(19) United States
(12) Patent Application Publication
(10) Pub. No.: US 2012/0163557 A1
(43) Pub. Date: Jun. 28, 2012

(54) METHODS AND PHANTOMS FOR CALIBRATING AN IMAGING SYSTEM

(76) Inventors: Jiang Hsieh, Brookfield, WI (US); Naveen Stephan Chandra, Kenosha, WI (US); Xiaoye Wu, Rexford, NY (US); Suresh Narayanan, Waukesha, WI (US); Dan Xu, Aurora, IL (US); Meghan Lynn Yue, Johnson Creek, WI (US)

(21) Appl. No.: 12/977,400

(22) Filed: Dec. 23, 2010

(51) Int. Cl. G01D 18/00

(52) U.S. Cl. 378/207

(57) ABSTRACT

A method for calibrating a medical imaging system includes performing an initial calibration of the imaging system, at a manufacturing site fabricating the imaging system, using a plurality of phantoms, shipping one of the phantoms to an installation site installing the imaging system, and performing a final calibration, at an installation site of the imaging system, using the shipped phantom. A set of calibration phantoms is also described herein.

### BACKGROUND OF THE INVENTION

This subject matter disclosed herein relates generally to imaging systems, and more particularly to methods and phantoms for calibrating a single or dual energy imaging system.

The performance of an x-ray computed tomography (CT) system is highly dependent on the quality of the calibration process. In general, calibration processes enable the reduction or elimination of suboptimal projection measurements caused by the fundamental properties of physics, e.g., beam hardening, limitation of the component performance, such as detector gain variation, and/or the non-ideal installation process, such as system alignment.

Before the introduction of virtual computed tomography (VCT), calibration was performed using a set of physical phantoms, such as water phantoms and/or poly phantoms, of various sizes. The phantoms were utilized to calibrate the CT imaging system at the factory and then shipped with each imaging system to the installation site. The phantoms remained at installation site for use in future calibrations, such as after a tube change. With the introduction of VCT, the cost and handling of the phantoms has become prohibitive. For example, as the axial or z-coverage of the CT system increases, the phantom length also increases, such that the phantom is substantially larger than the x-ray aperture to accurately model the scatter. However, the relatively large size of the phantom makes handling the phantoms more difficult. In addition, the cost associated with manufacturing such large phantoms increases significantly. For dual energy calibration, the phantom cost may be even higher if different materials are utilized to properly calibrate the system.

To overcome the difficulties associated with the cost and handling of such phantoms, “phantom-less calibration” is known. To perform phantom-less calibration, a single water phantom is used in the calibration process at the manufacturing site. Other parameters/settings of the system are characterized by performing a set of air scans and also using theoretical calculations. Although the phantom-less calibration reduces the cost and handling of the phantoms, accurately modeling a more complex imaging system, such as the VCT imaging system, is more difficult using a single phantom. For example, it is difficult to accurately model the scatter of the image system due to the object dependent nature of the imaging system.

### BRIEF DESCRIPTION OF THE INVENTION

In one embodiment, a method for calibrating a medical imaging system is provided. The method includes performing an initial calibration of the imaging system, at a manufacturing site fabricating the imaging system, using a plurality of phantoms, shipping one of the phantoms to an installation site installing the imaging system, and performing a final calibration, at an installation site of the imaging system, using the shipped phantom.

In another embodiment, another method for calibrating a medical imaging system is provided. The method includes performing a physics-based calibration and a component-based calibration of the imaging system at a manufacturing site fabricating the imaging system, using a plurality of phantoms, shipping one of the phantoms to an installation site installing the imaging system, and performing a system-based calibration of the imaging system using the shipped phantom.

In a further embodiment, a set of calibration phantoms for calibrating a medical imaging system is provided. The set of phantoms includes a first phantom having a first size, a second phantom having a second size, the first and second phantoms utilized to partially calibrate the imaging system at a manufacturer's site, and a third phantom to complete the calibration of the imaging system at an installation or follow-up calibration.

In a further embodiment, a set of calibration phantoms for calibrating a medical imaging system is provided. The set of phantoms includes a first phantom having a first material, a second phantom having a second material, the first and second phantoms utilized to partially calibrate the imaging system at a manufacture's site, and a third phantom to complete the calibration of the imaging system at an installation or follow-up calibration.

In a further embodiment, a set of calibration phantoms for calibrating a medical imaging system is provided. The set of phantoms includes a first phantom having a first shape, a second phantom having a second shape, the first and second phantoms utilized to partially calibrate the imaging system at a manufacture's site, and a third phantom to complete the calibration of the imaging system at an installation or follow-up calibration.

### BRIEF DESCRIPTION OF THE DRAWINGS

FIG. 1 illustrates a simplified block diagram of an exemplary imaging system that is formed in accordance with various embodiments.

FIG. 2 is a flowchart illustrating an exemplary method for calibrating an imaging system in accordance with various embodiments.

FIG. 3 is a block schematic diagram of an exemplary set of phantoms formed in accordance with various embodiments.

FIG. 4 is a pictorial view of an exemplary imaging system formed in accordance with various embodiments.

FIG. 5 is a block schematic diagram of the system illustrated in FIG. 4.

### DETAILED DESCRIPTION OF THE INVENTION

The foregoing summary, as well as the following detailed description of various embodiments, will be better understood when read in conjunction with the appended drawings. To the extent that the figures illustrate diagrams of the functional blocks of the various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

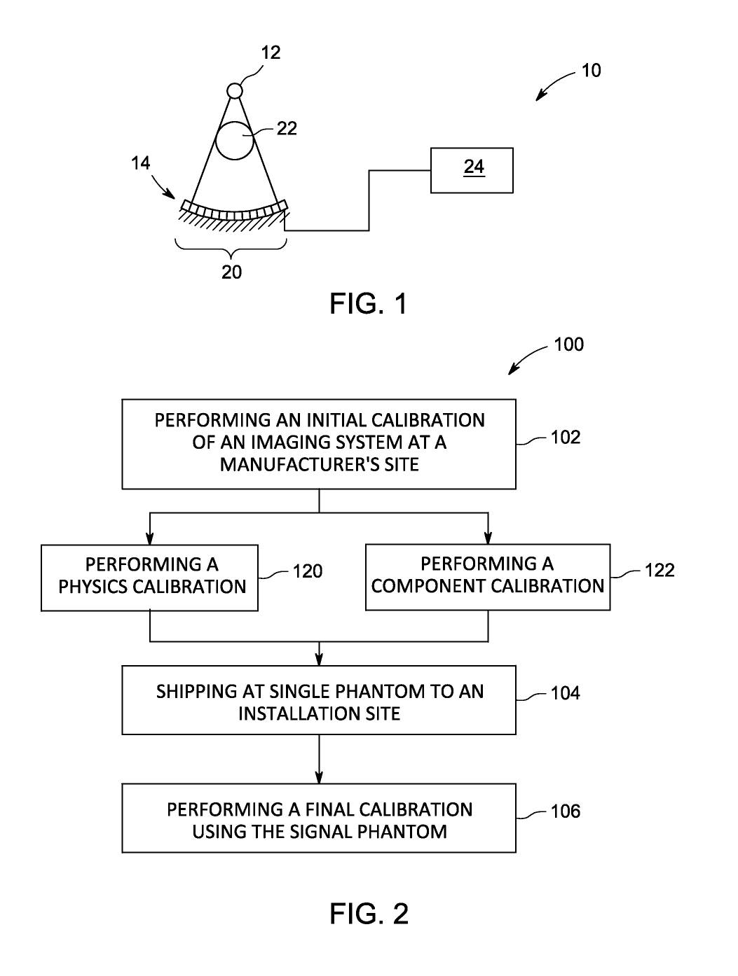

FIG. 1 illustrates a simplified block diagram of an exemplary imaging system 10 that is formed in accordance with various embodiments. In the exemplary embodiment, the imaging system 10 is a computed tomography (CT) imaging system that includes an X-ray source 12 and a detector 14. The detector 14 includes a plurality of detector elements 20, that are arranged in rows and channels, that together sense projected X-rays, from the X-ray source 12, that pass through an object, such as a phantom 22. Each detector element 20 produces an electrical signal, or output, that represents the intensity of an impinging X-ray beam and hence allows estimation of the attenuation of the beam as the beam passes through the phantom 22. The imaging system 10 also includes a computer 24 that receives the projection data from the detector 14, also referred to herein as raw data, and processes the projection data to reconstruct an image of the phantom 22. In various embodiments, the phantom 22 may be included in a set of phantoms, discussed in more detail below. The set of phantoms are utilized to enable the manufacturer of the imaging system 10 to perform a physics calibration and a component calibration at the manufacture's site which reduces the level of calibration that is accomplished at an installation site. The results of the calibration performed at the manufacturer's site are approximately equivalent to the results that would be achieved had this portion of the calibration been performed entirely at the installation site. Thus, the installer is no longer required to perform the full calibration procedure at the installation site.

FIG. 2 is a flowchart of an exemplary method 100 for calibrating an imaging system such as the imaging system 10 shown in FIG. 1. However, it should be realized that the methods of calibration described herein may be applied to any imaging system and the imaging system 10 shown in FIG. 1 is one embodiment of such an exemplary imaging system. The method 100 may be embodied as a set of instructions that are stored on the computer 24, for example.

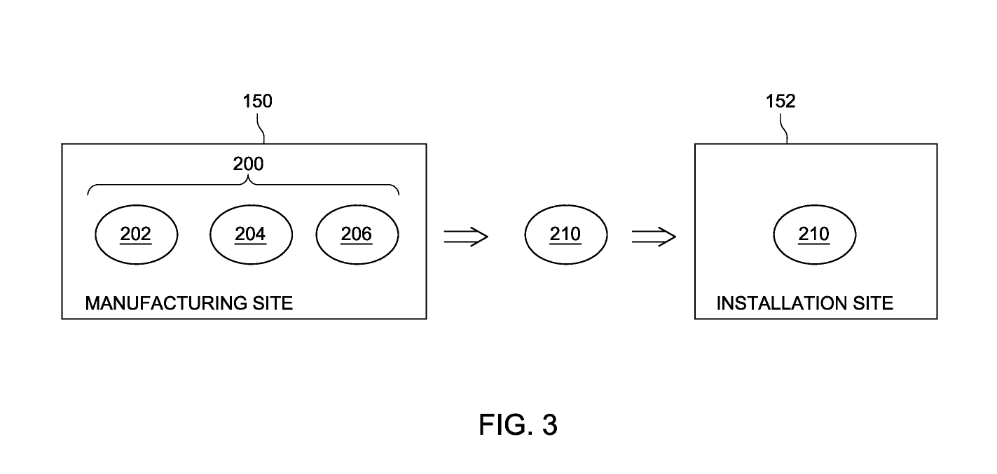

At 102, an initial calibration of the imaging system is performed at a manufacturing site. Manufacturing site as used herein is defined as the location or site wherein the major components that form the imaging system are brought together to enable a technician to assemble the major components to form the imaging system. Assembling the major components may include, for example, coupling an x-ray source and a detector to a gantry. Moreover, assembling the major components may also include, for example, assembling the various computers and controller that control the operation of the imaging system. In the exemplary embodiment, the manufacturing site is the location of the original equipment manufacturer (OEM) of the imaging system. For example, FIG. 3 is a block diagram illustrating a set of phantoms 200 used to calibrate the imaging system at a manufacturer's site 150 and at least one phantom 210 used to calibrate the imaging system at an installation site 152. In the exemplary embodiment, the installation site is defined as the location wherein the imaging system is configured for operation for its intended purpose. Such installation sites include, for example, hospitals and airports.

In the exemplary embodiment, calibrating at least a portion of the imaging system at the manufacturing site 150 includes performing at 120 a physics-based calibration of the imaging system at the manufacturing site 150. Performing a physics-based calibration includes calibrating the imaging system to correct for beam hardening, scatter radiation, off-focal radiation, and other inaccuracies that may be produced as a result of rotating the gantry during operation.

For example, the polychromatic nature of x-ray sources used in CT imaging systems, induces beam-hardening artifacts in the reconstructed images. In a human body being imaged, there are two main components that lead to distinct beam hardening effects: one arising from soft tissue and the other from bone. To complicate this matter, detection efficiency of detector elements changes with x-ray spectrum hardened by different materials, resulting in detection system related image artifacts. Accordingly, to calibrate for beam hardening, in one embodiment, a plurality of air scans may be performed. In the exemplary embodiment, the plurality of air scans are performed with the x-ray source set at different at a voltage levels (kVp). For example, a first air scan may be performed at a first kVp, a second air scan may be performed at a second different kVp, etc. The detection efficiencies of the detector may then be estimated using the projection values acquired from the detector. Thus, an ideal spectral effect may be modeled by simulation of an x-ray beam spectrum and its interaction with materials such as filters in the beam path and water phantoms. Deviation from the ideal model is determined from the measurements at multiple kVp's.

Scatter x-rays are x-rays that deviate from a straight trajectory. Scatter is typically caused by a localized non-uniformity in the object being imaged. In the exemplary embodiment, calibrating to generate a scatter correction includes utilizing the set of calibration phantoms 200, shown in FIG. 3, to calibrate the imaging system. In the exemplary embodiment, each phantom in the set of imaging phantoms 200 is imaged using the imaging system to generate a phantom image for each respective phantom. The phantom images are then processed to generate a plurality of calibration values to form a calibration curve or scatter correction. The calibration curve, or scatter correction, may then be applied to images generated after the imaging system is installed at the installation site. Referring again to FIG. 3, in the exemplary embodiment, the set of phantoms 200 includes a first phantom 202, a second phantom 204, and a third phantom 206. The phantoms 202, 204, and 206 each have a different size, different shape, or may be fabricated from different materials. For example, the phantom 202 may a length and width that is greater than a length and width of the phantom 204. Moreover, the phantom 204 may have a length and width that is greater than a length and a width of the phantom 206. In the exemplary embodiment, the lengths and widths of the various phantoms 200 are selected to facilitate calibrating the imaging system. For example, due to scatter kernel effects, the set of phantoms 200 may include a 20 cm water, a 35 cm poly, and a 48 cm poly. Optionally the set of phantoms 200 may all be formed as water phantoms. In another embodiment, the set of phantoms 200 may each be formed as poly phantoms. In yet another embodiment, one phantom in the set may be formed with water and another formed with poly. In yet another embodiment, one phantom in the set may have circular cross-section and another have oval cross-section. In yet another embodiment, the set of phantoms may be connected to form a “wedding cake” style single phantom. The wedding cake phantom may be formed to include a plurality of phantom portions that are formed as disks having different diameters. Each disk may have inserts for measuring various imaging parameters described herein. The various inserts, may include, for example, comb phantoms, wires, and/or low contrast objects.

For example, if the imaging system 10 is embodied as a dual-energy imaging system, the set of phantoms 200 may include phantoms 200 shaped in stair-step fashion and/or fabricated from two or more materials that characterize the attenuation characteristics of the dual-energy CT scanners. The measurements from these phantoms 200 may then be utilized to generate mapping functions in the material decomposition process. In another embodiment, the set of phantoms 200 may include at least one phantom that is rectangular, or non-rectangular, e.g. “pointed” to facilitate pointing the phantom element to a source focal spot. Additionally, the set of phantoms 200 may include phantoms having different geometries.

Calibrating the physics may also include calibrating a focal spot size and/or shape of the x-ray source. In operation, the focal spot may be calibrated by positioning a phantom, such as one of the phantoms in the phantom set 200, between the detector and the x-ray source. A plurality of images may then be acquired of the phantoms 200. The position and size of the focal spot of the x-ray source relative to the detector may then be determined using the acquired images.

In the exemplary embodiment, calibrating at least a portion of the imaging system at the manufacturing site also includes performing at 122 a component-based calibration of the imaging system at the manufacturing site 150. The component based calibration includes, for example, determining the spectral response of the detector, the output from the x-ray source, the filtering caused by a bowtie filter, etc.

For example, as discussed above, the detector includes a plurality of detector elements which together sense the projected x-rays that pass through the patient. For calibration purposes, a phantom, such as one of the phantoms in phantom set 200, is used to represent the patient. In operation, spectral errors that appear in reconstructed CT images may result from the uncontrolled filtration of the detector, for example, shadowing of an antiscatter collimator, and differences in signal production efficiency between the detector elements as a function of incident photon energy. Thus, an incident x-ray spectrum attenuated by the same thickness of water will result in unequal signals being produced from the different detector elements. Because attenuation of the x-rays through water is strongly dependent upon photon energy, and detection efficiency is also a function of photon energy, a difference in detected signal cannot be compensated using air measurements. Thus, in the exemplary embodiment, the spectral response of the detector is acquired by performing a plurality of air scans at various kVp settings of the x-ray source. A detection efficiency for each detector element is then determined using changes in detected signal from these scans. Spectral errors for various path lengths of water absorber (e.g. a water-based phantom used as the patient) are determined using a priori knowledge of the initial x-ray spectrum, the materials of a beam filter (not shown in the figures), and the detector element detection efficiencies as a function of photon energy. In operation, if the incident x-ray spectra is well-controlled, beam hardening effects can be accurately predicted and removed.

At 104, in one embodiment, at least one of the phantom is shipped to the installation site 152 for future calibration of the imaging system. In the exemplary embodiment, only a single phantom 210 in the set of phantoms 200 is shipped to, and utilized by, the installation site 152 to complete the calibration of the imaging system. Optionally, multiple phantoms may be used to calibrate the imaging system at the installation site. In one embodiment, the phantom 210 may be a phantom included in the set of phantoms 200. In another embodiment, the phantom 210 may be a different phantom that is not in the set of phantoms 200 and is therefore not utilized to perform the physics and component calibration at the manufacturer's site 150 as discussed above.

At 106, the phantom received at the installation site 152 is utilized to perform a final calibration of the imaging system at the installation site 152. As discussed above, in the exemplary embodiment, the physics and component level calibration is performed at the manufacturer's site using a plurality of phantoms 200. However, in the exemplary embodiment, only a single phantom 210 is utilized to complete the calibration process at the installation site 210. More specifically, the various embodiments described herein enable a technician to perform a complete calibration on the imaging system, which performing a portion of the complete calibration procedure at the manufacturer's site 150 and performing the remaining portion of the imaging system calibration at the installation site 152.

Accordingly, a first portion of the calibration procedure, performed at the manufacturer's site 150, characterizes component-based imperfections and physics based imperfections. These component and physics based imperfections should remain approximately the same between the manufacturer's site and the installation site. For example, the scattered radiation associated with the phantom and bowtie filter and the spectral response of the detector, the focal spot size, shape and spectrum are characteristics that should remain substantially unchanged between the manufacturer's site 150 and the installation site 152 so as not to effect operation and to allow for clinically relevant images to be acquired. However, the calibration performed at the manufacturer's site does not fully characterize the slight misalignment during the final system installation or tube spectrum drift over time. Therefore, in the exemplary embodiment, at 106, an added air and water phantom calibration is performed at the installation site 152 to finely tune the alignment of, for example, the table with the gantry, etc. As a result, fewer phantoms are utilized to perform the final calibration at the installation site than are used to perform the calibration at the manufacturing site.

At least one technical effect of various embodiments described herein is to perform a full imaging system calibration while also reducing the quantity of phantoms being delivered to an installation site. Thus, the overall cost of the imaging system is reduced. More specifically, various embodiments describe a full calibration procedure wherein full phantom scans are performed at a manufacturer's site during the manufacturing process. The results of the calibration performed at the manufacturer's site are approximately equivalent to the results that would be achieved had this portion of the calibration been performed at the installation site. Thus, the installer is no longer required to perform the full calibration procedure at the installation site. More specifically, the scattered radiation associated with the phantom, the bowtie filter, the spectral response of the detector, the focal spot size, shape and spectrum are characteristics that should remain substantially unchanged between the manufacturer's site and the installation site. At the installation site, an added air and water phantom calibration may be performed as a fine adjustment on the imaging system to correct for slight misalignments caused by shipping the imaging system, etc. In various embodiments, the same calibration procedure discussed above, may also be applied to dual energy imaging systems. For example, in fast kVp switching calibrations, air scans may be acquired with the fast kVp switching mode as well as 80 kVp and 140 kVp modes individually. In addition, a water phantom scan may be performed to calibrate the system. Other material-dependent calibrations may also be performed based on the theoretical calculation.

Exemplary embodiments of a multi-modality imaging system are described above in detail. The multi-modality imaging system components illustrated are not limited to the specific embodiments described herein, but rather, components of each multi-modality imaging system may be utilized independently and separately from other components described herein.

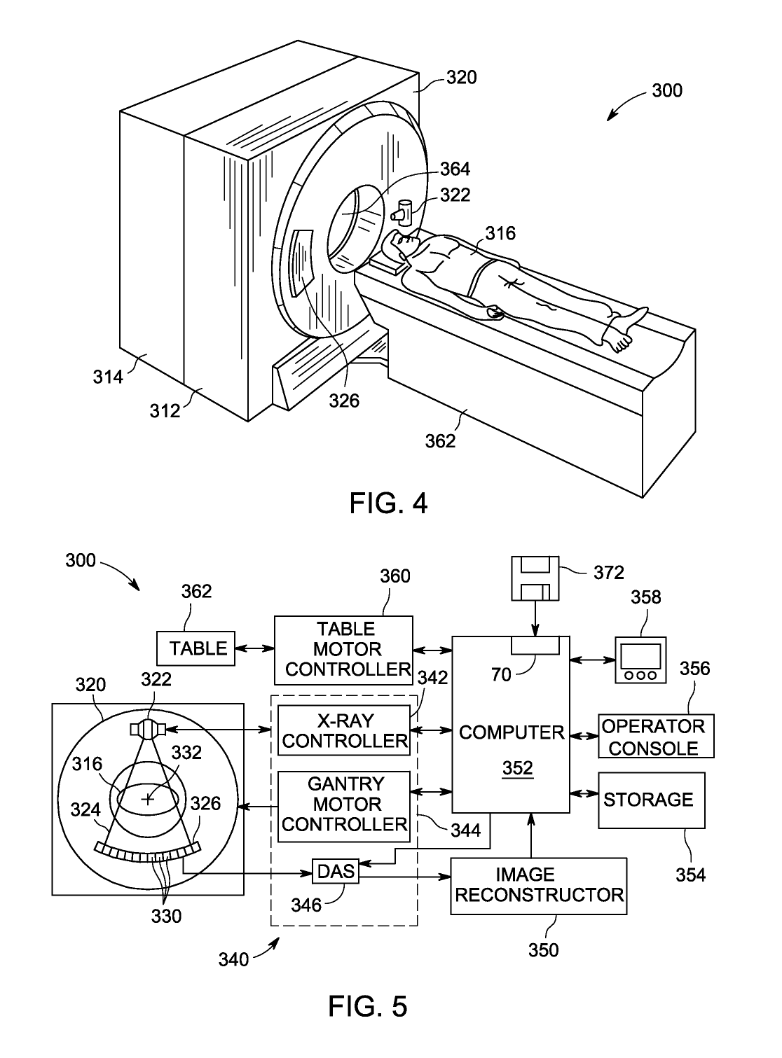

For example, the multi-modality imaging system components described above may also be used in combination with other imaging systems such as an imaging system shown in FIGS. 4 and 5. More specifically, FIG. 4 is a pictorial view of an exemplary multi-modality imaging system 300 that is formed in accordance with various embodiments. FIG. 5 is a block schematic diagram of the multi-modality imaging system 300 illustrated in FIG. 4. Although various embodiments are described in the context of an exemplary dual modality imaging system that includes a computed tomography (CT) or a virtual computed tomography (VCT) imaging system and a PET imaging system, it should be understood that other imaging systems capable of performing the functions described herein are contemplated as being used.

The multi-modality imaging system 300 is illustrated and includes a first modality unit 312 and a second modality unit 314. The two modality units, 312 and 314, enable the system 300 to scan a patient 316 in a first modality using the first modality unit 312 and to scan the patient 316 in a second modality using the second modality unit 314. The system 300 allows for multiple scans in different modalities to facilitate an increased diagnostic capability over single modality systems. In one embodiment, the multi-modality imaging system 300 is a Positron Emission Tomography/Computed Tomography (PET/CT) imaging system 300. Optionally, modalities other than CT and PET are employed with system 300. For example, the first modality 312 may be a virtual computed tomography (VCT) imaging system. The first modality unit 312, e.g. the CT/VCT imaging system, includes a gantry 320 that has an x-ray source 322 that projects a beam of x-rays 324 toward a detector array 326 on the opposite side of the gantry 320. The detector array 326 includes a plurality of detector elements 330, that are arranged in rows and channels, that together sense the projected x-rays that pass through an object, such as the patient 316.

Each detector element 330 produces an electrical signal, or output, that represents the intensity of an impinging X-ray beam and hence allows estimation of the attenuation of the beam as it passes through the patient 316. During a scan to acquire x-ray projection data, the gantry 320 and the components mounted thereon rotate about a center of rotation 332. FIG. 5 shows only a single row of detector elements 30 (i.e., a detector row). However, the multislice detector array 326 includes a plurality of parallel detector rows of detector elements 330 such that projection data corresponding to a plurality of slices can be acquired concurrently during a scan.

Rotation of the gantry 320 and the operation of the x-ray source 322 are governed by a control mechanism 340 of the PET/CT system 300. The control mechanism 340 includes an x-ray controller 342 that provides power and timing signals to the x-ray source 322 and a gantry motor controller 344 that controls the rotational speed and position of the gantry 320. A data acquisition system (DAS) 346 in the control mechanism 340 samples analog data from detector elements 330 and converts the data to digital signals for subsequent processing. An image reconstructor 350 receives the sampled and digitized x-ray data from the DAS 346 and performs high-speed image reconstruction. The reconstructed image is applied as an input to a computer 352 that stores the image in a storage device 354. The computer 352 also receives commands and scanning parameters from an operator via a console 356 that has a keyboard. An associated visual display unit 358 allows the operator to observe the reconstructed image and other data from computer.

The operator supplied commands and parameters are used by the computer 352 to provide control signals and information to the DAS 346, the x-ray controller 342 and the gantry motor controller 344. In addition, the computer 352 operates a table motor controller 360 that controls a motorized table 362 to position the patient 316 in the gantry 320. Particularly, the table 62 moves at least a portion of the patient 316 through a gantry opening 364.

In one embodiment, the computer 352 includes a device 370, for example, a floppy disk drive, CD-ROM drive, DVD drive, magnetic optical disk (MOD) device, or any other digital device including a network connecting device such as an Ethernet device for reading instructions and/or data from a computer-readable medium 372, such as a floppy disk, a CD-ROM, a DVD or an other digital source such as a network or the Internet, as well as yet to be developed digital means. In another embodiment, the computer 352 executes instructions stored in firmware (not shown). The computer 352 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

In the exemplary embodiment, the x-ray source 322 and the detector array 326 are rotated with the gantry 320 within the imaging plane and around the patient 316 to be imaged such that the angle at which the x-ray beam 324 intersects the patient 316 constantly changes. A group of x-ray attenuation measurements, i.e., projection data, from the detector array 326 at one gantry angle is referred to as a “view”. A “scan” of the patient 316 includes a set of views made at different gantry angles, or view angles, during one revolution of the x-ray source 322 and the detector 326.

The x-ray source 322 may be configured to perform a scan of the patient 316 using a single x-ray energy. Optionally, the x-ray source 322 may be configured to perform a scan of the patient 316 using a multiple energy levels. For example, in a dual energy scan, two x-ray spectrums are produced concurrently at different kV levels. The results are two CT data sets, allowing differentiating, characterizing, isolating, and distinguishing the imaged material. Additionally, dual energy CT with better differentiation between lower energy and higher energy spectrum may reduce beam hardening artifacts. Such artifacts are generally encountered in cranial scanning. Having two energy spectrums eliminates the beam hardening. Further, inherent filtration of x-ray spectrum helps improve fidelity of signal to background noise. Moreover, the contrast to noise ration as measured by the difference between CT number of two object is enhanced by having clear difference between lower energy and higher energy x-ray spectrum.

In a CT scan, the projection data is processed to reconstruct an image that corresponds to a two dimensional slice taken through the patient 316. One method for reconstructing an image from a set of projection data is referred to in the art as the filtered back projection technique. This process converts the integral attenuation measurements into an image representing attenuation of the patient in each pixel. The attenuation measurements are typically converted into units of CT numbers or Hounsfield units.

To reduce the total scan time, a “helical” scan may be performed. To perform a “helical” scan, the patient 316 is moved while the data for the prescribed number of slices is acquired. Such a system generates a single helix from a fan beam helical scan. The helix mapped out by the fan beam yields projection data from which images in each prescribed slice may be reconstructed. Multiple helices are obtained using a multi-slice detector.

Reconstruction algorithms for helical scanning typically use helical weighing algorithms that weight the collected data as a function of view angle and detector channel index. Specifically, prior to the filtered back projection process, the data is weighted according to a helical weighing factor that is a function of both the gantry angle and detector angle. The weighted data is then processed to generate CT numbers and to construct an image that corresponds to a two dimensional slice taken through the patient 16. During operation of multi-slice PET/CT system 300, multiple projections are acquired concurrently with multiple detector rows. Similar to the case of helical scan, weighting functions are applied to the projection data prior to the filtered back projection process.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Also as used herein, the phrase “reconstructing an image” is not intended to exclude embodiments of the present invention in which data representing an image is generated, but a viewable image is not. Therefore, as used herein the term “image” broadly refers to both viewable images and data representing a viewable image. However, many embodiments generate, or are configured to generate, at least one viewable image.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for calibrating a medical imaging system, said method comprising:
performing an initial calibration of the imaging system, at a manufacturing site fabricating the imaging system, using a plurality of phantoms; and
performing a final calibration, at an installation site of the imaging system, using one or more phantoms received from a manufacturer of the imaging system, which are fewer in number than the plurality of phantoms.

2. The method of claim 1 wherein performing the initial calibration includes performing a physics based calibration and a component based calibration.

3. The method of claim 1 wherein performing the physics based calibration includes correcting for at least one of beam hardening, scatter radiation, material-density inaccuracy, or off-focal radiation.

4. The method of claim 1 wherein performing the physics based calibration includes determining a spectral response of a detector, an output from an x-ray source, or a filtering caused by a bowtie filter.

5. The method of claim 1 wherein performing a final calibration includes aligning an imaging system table to an imaging system gantry.

6. The method of claim 1 further comprising:
performing an initial calibration of a dual-energy imaging system, at a manufacturing site fabricating the imaging system, using a plurality of phantoms; and
performing a final calibration, at an installation site of the dual-energy imaging system, using the shipped phantom using the phantom received from a manufacturer of the imaging system.

7. The method of claim 1 further comprising performing an initial calibration of the imaging system, at a manufacturing site fabricating the imaging system, using a plurality of phantoms that include at least two phantoms having different sizes.

8. The method of claim 1 wherein performing a final calibration further comprises performing an air calibration and a water calibration using the shipped phantom.

9. A method for calibrating a medical imaging system, said method comprising:
performing a physics-based calibration and a component-based calibration of the imaging system at a manufacturing site fabricating the imaging system, using a plurality of phantoms;
shipping one of the phantoms to an installation site installing the imaging system; and
performing a system-based calibration of the imaging system using the shipped phantom.

10. The method of claim 9 wherein performing the physics based calibration includes correcting for at least one of beam hardening, scatter radiation, material-density inaccuracy, or off-focal radiation.

11. The method of claim 9 wherein performing the physics based calibration includes determining a spectral response of a detector, an output from an x-ray source, or a filtering caused by a bowtie filter.

12. The method of claim 9 wherein performing a final calibration includes aligning an imaging system table to an imaging system gantry.

13. The method of claim 9 further comprising:
performing an initial calibration of a dual-energy imaging system, at a manufacturing site fabricating the imaging system, using a plurality of phantoms;
shipping one of the phantoms to an installation site installing the dual-energy imaging system; and
performing a final calibration, at an installation site of the dual-energy imaging system, using the shipped phantom.

14. The method of claim 9 further comprising performing an initial calibration of the imaging system, at a manufacturing site fabricating the imaging system, using a plurality of phantoms that include at least two phantoms having different sizes.

15. The method of claim 9 wherein performing a final calibration further comprises performing an air calibration and a water calibration using the shipped phantom.

16. A set of calibration phantoms for calibrating a medical imaging system, said set comprising:
a first phantom having a first size;
a second phantom having a second size, the first and second phantoms utilized to partially calibrate the imaging system at a manufacturer's site; and
a third phantom to complete the calibration of the imaging system at an installation site.

17. The set of phantoms of claim 16 wherein the first and second phantoms comprises water phantoms.

18. The set of phantoms of claim 16 wherein the third phantom is different than the first or second phantoms.

19. The set of phantoms of claim 16 wherein the first and second phantoms are utilized to perform a physics based calibration and a component based calibration of the imaging system.

20. The set of phantoms of claim 16 wherein the third phantom is utilized to perform a system calibration of the imaging system.
